(19) United States
(12) Patent Application Publication
(10) Pub. No.: US 2008/0268966 A1
(43) Pub. Date: Oct. 30, 2008

(54) THREAD CHASER

(76) Inventor: Nicholas Andrew Pawloski, Portland, ME (US)

Correspondence Address: MOORE & VAN ALLEN PLLC, P.O. BOX 13706, Research Triangle Park, NC, 27709, US

(21) Appl. No.: 11/740,992

(22) Filed: Apr. 27, 2007

(51) Int. Cl. B23G 5/04

(52) U.S. Cl. 470/185

(57) ABSTRACT

A thread chaser device comprises an elongated member. A coupling mechanism is formed at one end of the member. A thread cutting device is formed at the other end of the member and is spaced from the coupling mechanism. The elongated member may define an internal bore located between the coupling mechanism and the thread cutting device. In one embodiment the thread chaser device may be at least two inches long and has a thin walled construction. The bore may closely receive a stud to maintain the angular orientation of the thread chaser relative to the stud.

The invention relates generally to dies for cutting or cleaning screwthreads and, more particularly, to a device suitable for use in obstructed areas and/or for long studs.

Threaded dies are known for cutting or repairing and cleaning threads in a stud. These devices may be used to cut threads into virgin unthreaded stock or may be used to clean out and repair damaged, dirty or rusted threads in a threaded member. When used to form threads the devices are typically referred to as thread cutters and when used to clean or repair existing threads the devices are typically referred to as thread chasers. These devices are referred to collectively herein as thread chasers.

Thread chasers typically comprise a relatively shallow die having a depth of between approximately ¼ and 1 inch. The thread chasers typically have an internally threaded bore that is sized to fit onto a like-sized stud. The threaded bore extends for substantially the entire depth of the device. The threads may be formed as split threads rather than as a continuous thread to facilitate the cutting action and to allow the ejection of debris from the die. The die typically comprises a relatively thick wall design where the walls of the die are relatively thick compared to the die's overall depth. The die may include a hexagonal or round peripheral face that is intended to be gripped by a turning tool such as a conventional wrench, die stock, die handle or the like. The die is placed over the stud and is rotated by the appropriate turning tool to cut threads into the stud or to clean and repair existing threads. The threads on the thread chaser may be arranged to be used with either left or right hand threads.

One problem with known dies is that because the dies are relatively shallow and must be gripped by the turning tool about their outer periphery, it can be very difficult or impossible to use the dies in close or obstructed spaces. Further, with long studs, the relatively shallow dies can become angularly misaligned relative to the stud as the die is rotated onto the stud.

Thus, an improved thread chaser is desired.

### SUMMARY OF THE INVENTION

A thread chaser device comprises an elongated member. A coupling mechanism is formed at one end of the member. A thread cutting device is formed at the other end of the member and is spaced from the coupling mechanism. The elongated member may define an internal bore located between the coupling mechanism and the thread cutting device. The bore may closely receive a stud to maintain the angular orientation of the thread chaser relative to the stud.

### BRIEF DESCRIPTION OF THE DRAWINGS

FIG. 1 is a perspective view of an embodiment of the thread chaser of the invention.

FIG. 2 is a longitudinal section view of the embodiment of the thread chaser of FIG. 1.

FIG. 3 is a first end view of the embodiment of the thread chaser of FIG. 1.

FIG. 4 is a second end view of the embodiment of the thread chaser of FIG. 1.

FIG. 5 is a perspective view of an alternate embodiment of the thread chaser of the invention.

FIG. 6 is a perspective view of another alternate embodiment of the thread chaser of the invention.

FIG. 7 is a perspective view of yet another alternate embodiment of the thread chaser of the invention.

FIGS. 8a and 8b are partial section views of the embodiment of the thread chaser of FIG. 1 in use.

FIG. 9 is a section view of an embodiment of the thread chaser in use.

FIG. 10 is a plan view of a kit with a thread chaser as shown in FIG. 1.

### DETAILED DESCRIPTION OF EMBODIMENTS OF THE INVENTION

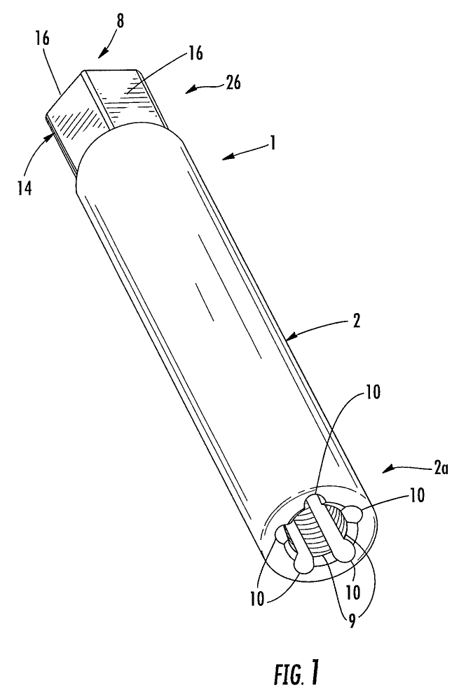

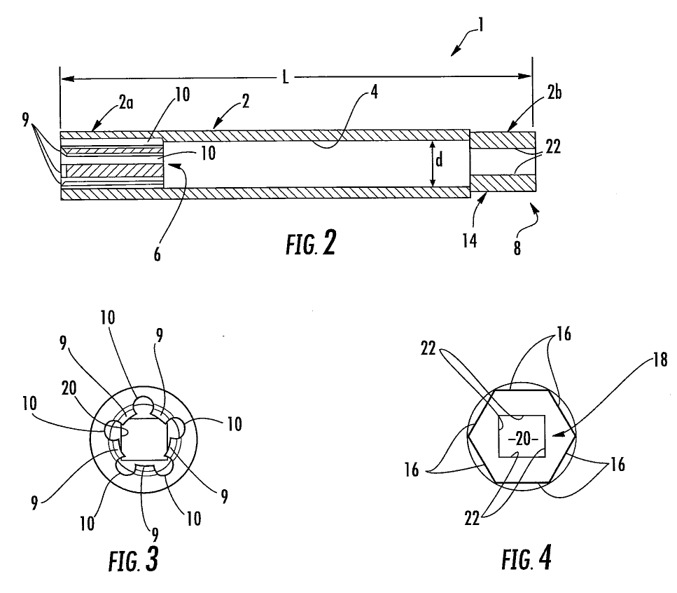

Referring to FIGS. 1 through 4 an embodiment of the thread chaser is shown generally at 1 comprising an elongated member 2 having a longitudinally extending bore 4. The member 2 has a first end 2a with a thread cutting tool 6 formed therein and a second end 2b with a turning tool coupling mechanism 8.

In one embodiment the overall length L of the thread chaser 1 is approximately two inches. The length of the thread chaser 1 may vary based on the specific application of the device. A length of 2.5 inches has been found suitable for many applications such as engine repair. The thread chaser may be made somewhat shorter or significantly longer depending on the accessibility and/or length of the stud on which it is intended to be used. For example, the thread chaser 1 may be approximately 50% longer than a conventional die up to approximately six inches long for most applications. The thread chaser may be made longer than six inches for specialty applications. The thread chaser 1 is longer than existing thread chasers where the over all length of the thread chaser is typically no longer than the extent of the internal threads.

The first end 2a is formed with a thread cutting tool 6 for engaging a stud and cutting new threads or chasing existing threads. The thread cutting tool 6 as shown comprises internal threads 9 that engage the stud to cut or repair the threads. The internal threads 9 may be formed as split threads, as shown, or as a continuous thread. Split threads comprise a plurality of threaded portions 9 arranged about the interior of bore 4 and spaced by non-threaded relief sections 10 that facilitate the cutting action and allow the ejection of debris from the die. With split threads the threaded portions 9 are arranged such that the threads of one portion are a continuation of the threads of the adjacent portions.

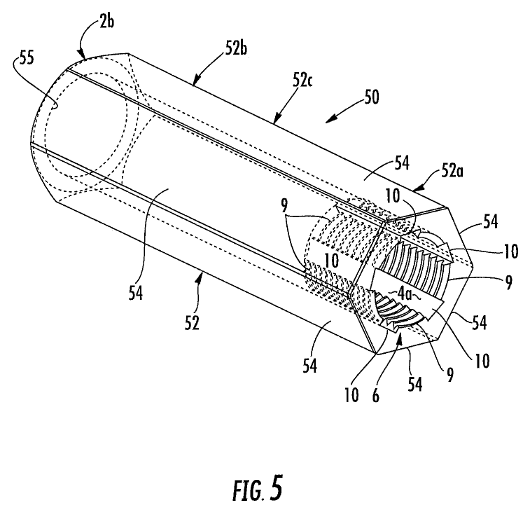

The second end 2b is formed with a turning tool coupling mechanism 8 for connecting the thread chaser to a turning tool such as a conventional wrench, socket wrench, tap wrench, tap handle or the like. Coupling mechanism 8 comprises a male or external turning tool coupling mechanism 14 that is intended to be gripped by a turning tool such as a tap wrench, conventional wrench or the like. In the illustrated embodiment the external coupling mechanism 14 comprises a hexagonal coupler having six flat faces 16 as best shown in FIG. 4. Other coupling mechanisms may be used depending on the turning tool that is to be used with the thread chaser.

The coupling mechanism 8 may further include a female or internal coupling mechanism 18 dimensioned to receive a male turning tool as best shown in FIG. 4. The turning tool may comprise a power driver or ratchet socket wrench where the internal coupling mechanism 10 comprises a receptacle 20 defined by a plurality of flat faces 22 that mate with the fitting of the turning tool. Because the coupling mechanisms 14 and 18 are spaced from the first end 2a by the length of the member 2, the thread chaser may be positioned on a threaded member in a hard to reach location and a turning tool can still be applied to either the first or second coupling mechanisms. While the illustrated embodiment shows two coupling mechanisms 14 and 18 only one coupling mechanism may be provided.

Between the first end 2a and the second end 2b is internal bore 4 that is substantially cylindrically shaped. The outer dimension of the member 2 and the internal diameter of bore 4 are selected such that the thread chaser 1 has a thin walled construction. Thin walled construction is defined by a thread chaser where the external diameter or width of the thread chaser is no greater than the industry standard for the outside diameter of a deep socket wrench that would be used with the threaded fastener being chased. For example, if a ¼-20NC stud accepts a 7/16 inch hex nut, the outside diameter of the thread chaser used on that stud would be no larger than the outside diameter for the industry standard of a deep socket used on that stud. In one embodiment the wall thickness may be approximately two times the thread height.

The internal bore 4 has a diameter that is approximately equal to but slightly greater than the diameter of the stud on which the thread chaser 1 is intended to be used. As a result, a stud on which the thread chaser is used will be closely received within the bore 24 to maintain the screw chaser 1 in alignment with the stud even if the stud is relatively long. Because the thread chaser 1 is approximately two inches long or longer and the threads 9 extend into the bore 4 for approximately three quarters of an inch, the major portion of bore 4 is unthreaded.

Referring to FIG. 5 an alternate embodiment of the thread chaser is shown generally at 50 and is similar to the thread chaser 1 previously described with respect to FIG. 1 where like numerals are used to identify like elements previously described with reference to FIGS. 1 through 4. In the embodiment of FIG. 5 the external coupling mechanism 52 extends for the length of the thread chaser. As shown the external coupling mechanism 52 comprises a plurality of flat faces 54 arranged to form a hexagonal gripping surface to be gripped by a turning tool such as a wrench or the like. A first portion of the coupling mechanism 52a is arranged adjacent the cutting tool 6 and a second portion of the coupling mechanism 52b is arranged spaced from the cutting tool 6 along the longitudinal axis of the thread chaser and in proximity to the distal end 2b. As a result, the thread chaser 50, space permitting, may be gripped by a turning tool adjacent cutting tool 6 at first portion 52a or remote from the cutting tool 6 at second portion 52b. The thread chaser may also be gripped in central portion 52c. Such a configuration allows maximum flexibility for gripping the thread chaser where access to the thread chaser may be limited or obstructed.

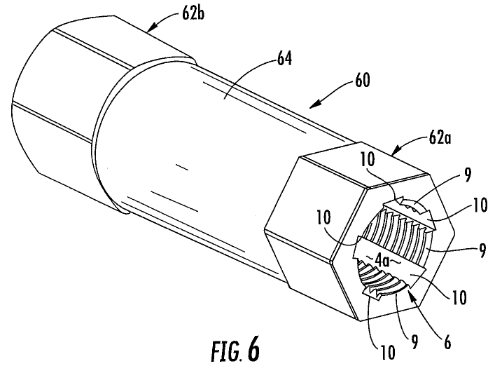

Another embodiment of the thread chaser of the invention is shown generally at 60 in FIG. 6 and is similar to the embodiment of FIG. 5 where like numerals are used to identify like elements previously described with reference to FIGS. 1 through 4. In the embodiment of FIG. 6 the first portion 62a of the external coupling mechanism is spaced from the second portion 62b of the external coupling mechanism by central portion 64. Like the embodiment of FIG. 5, the thread chaser 60, space permitting, may be gripped by a turning tool at first portion 62a adjacent the cutting tool 6 or remote from the cutting tool 6 at second portion 62b.

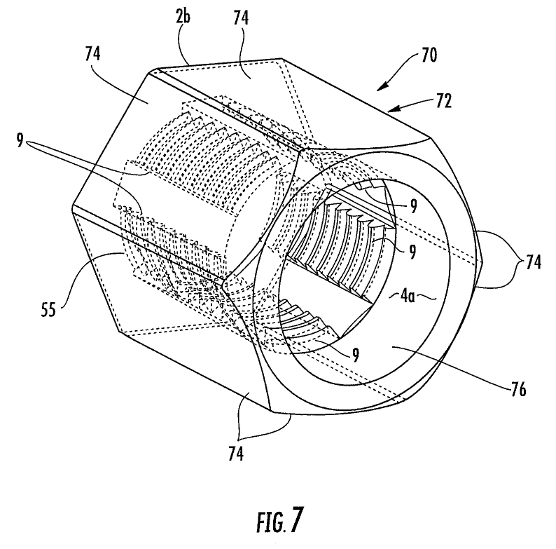

Another embodiment of the thread chaser of the invention is shown generally at 70 in FIG. 7 and is similar to the embodiment of FIG. 5 where like numerals are used to identify like elements previously described with reference to FIGS. 1 through 4. In the embodiment of FIG. 7 the external coupling mechanism 72 extends for the length of the thread chaser. As shown, the external coupling mechanism 72 comprises a plurality of flat faces 74 arranged to form a hexagonal gripping surface to be gripped by a turning tool such as a wrench or the like. In the embodiment of FIG. 7 the unthreaded portion 76 of internal bore 78 extends for a minor portion of the bore and threads 9 extend for a major portion of the bore 4a. Such an arrangement may be applicable where the overall depth of the thread chaser is on the order of 50% greater than a traditional thread chaser.

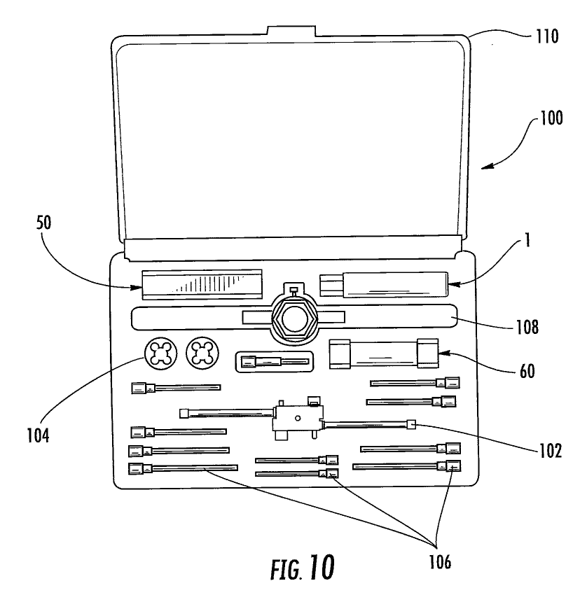

Referring to the embodiments of the thread chasers shown in FIGS. 5, 6 and 7 the internal coupling mechanism 18 of the embodiment of FIGS. 1 through 4 is eliminated such that the internal bore 4a extends through the distal end of the device such that the device has an opening 55 at its second end 2b dimensioned to receive a stud. The thread chaser illustrated in FIG. 1 may also be configured with bore 4 extending through the end 2b of the thread chaser to create opening 55 for receiving the stud as shown in FIG. 9. Further the embodiments of FIGS. 5, 6 and 7 may be provided with the internal coupling mechanism 18 as shown in FIG. 1.

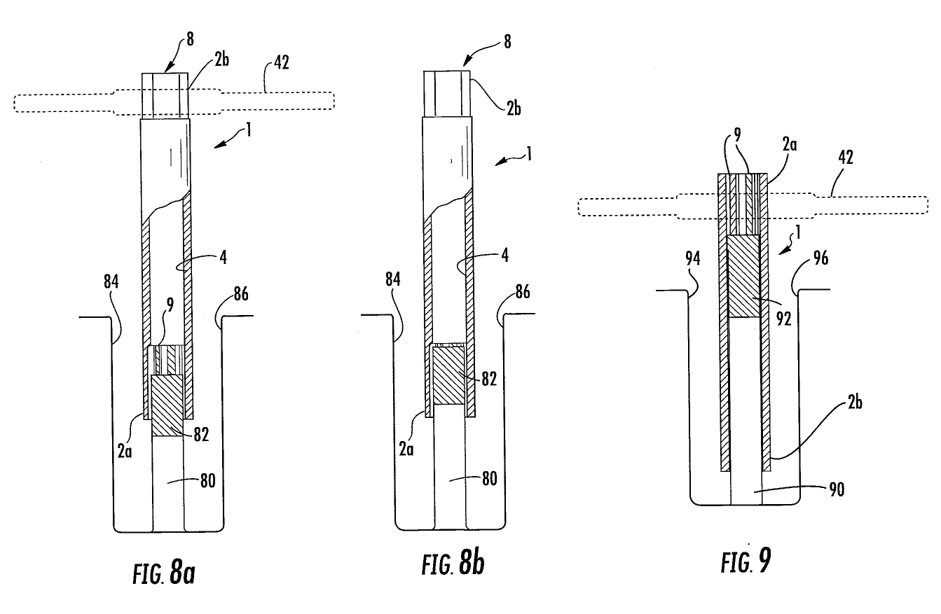

Referring the FIGS. 8a and 8b the stud chaser 1 is shown mounted on a long stud 80. The stud 80 has threads 82 formed thereon that may be damaged, rusted, obstructed by debris or otherwise inoperable. Stud 80 may also comprise unthreaded virgin stock. The illustrated stud is also shown in an obstructed area where access to the stud is limited due to its proximity to other components 84 and 86 such as may be found in an engine block. The thread chaser 1 is located on the stud 80 such that internal threads 9 engage the threads 82 formed on the stud. As is illustrated in FIG. 8a, the length of the thread chaser 1 allows the second end 2b to extend beyond the obstructions 84 and 86 such that coupling mechanism 8 can be gripped by a turning tool such as tap wrench 42. As the thread chaser 1 is threaded onto the stud 80, the stud extends into the elongated bore 4 where it is closely received within the bore as best shown in FIG. 8b. Because the stud 80 is closely received in bore 4, the thread chaser will not become angularly misaligned with respect to the longitudinal axis of the stud as can occur with existing thread chasers.

Referring to FIG. 9 the stud chaser 1 is shown mounted on a long stud 90. The stud 90 has threads 92 formed thereon that may be damaged, rusted, obstructed by debris or otherwise inoperable. Stud 90 may also comprise unthreaded virgin stock. The illustrated stud is also shown in an obstructed area where access to the stud is limited due to its proximity to other components 94 and 96 such as may be found in an engine block. The thread chaser is mounted on the stud such that the stud is inserted into the non-threaded end 2a of bore 4. The stud extends through bore 4 until it engages threads 9 where it is rotated to the chase or cut the threads in the stud 90. By inserting the stud into the non-threaded end of the thread chaser 1 the internal bore 4 acts as guide to ensure that the longitudinal axis of the thread chaser does not become misaligned with the longitudinal axis of the stud. The thread chaser may be formed as shown in FIGS. 5 and 6 such that a coupling mechanism is provided on end 2a such that the thread chaser may be engaged by a turning tool such as wrench 42 without interference from obstructions 94 and 96.

The thread chaser may be made and sold in a variety of sizes such that it can be used on studs/threads of different sizes and pitches. Moreover, the thread chaser 1 can be sold individually or as part of a kit 100 as shown in FIG. 10. When sold as part of a kit, the thread chaser 1 may be sold with other thread chasers 1 made in accordance with the invention where the thread chasers are of different sizes and/or configurations. The thread chasers may also be sold with other components such as a tap wrench 102, traditional thread chasers 104, taps 106, handle 108, thread pitch guides or the like. The kit may be packaged in a reuseable case 110 such as a recloseable plastic clam shell. The components may also be sold as subsets of the entire kit.

Specific embodiments of an invention are described herein. One of ordinary skill in the art will recognize that the invention has other applications in other environments. In fact, many embodiments and implementations are possible. The following claims are in no way intended to limit the scope of the invention to the specific embodiments described above.

1. A thread chaser device comprising:
an elongated member having a longitudinal axis;
a coupling mechanism formed at one end of the member;
a thread cutting device formed at another end of the member and spaced from at least a portion of the coupling mechanism along the longitudinal axis.

2. The thread chaser device of claim 1 wherein said elongated member defines an internal bore located between the coupling member and said thread cutting device.

3. The thread chaser device of claim 2 wherein said internal bore extends from said thread cutting device.

4. The thread chaser device of claim 1 wherein said thread cutting device comprises threads.

5. The thread chaser device of claim 1 wherein said thread cutting device comprises split threads.

6. The thread chaser device of claim 1 wherein said coupling mechanism includes an internal coupling mechanism and an external coupling mechanism.

7. The thread chaser device of claim 1 wherein said coupling mechanism includes a plurality of flat faces formed about the periphery of the elongated member.

8. The thread chaser device of claim 1 wherein said coupling mechanism includes a plurality of flat faces formed about an internal receptacle.

9. The thread chaser device of claim 1 wherein said elongated member is at least two inches long.

10. The thread chaser device of claim 1 wherein said elongated member is thin walled.

11. The thread chaser device of claim 2 wherein the bore receives a stud when the thread chaser device is threaded onto said stud.

12. The thread chaser device of claim 10 wherein the bore closely receives said stud to maintain the angular orientation of the thread chaser relative to said stud.

13. The thread chaser device of claim 1 wherein thread cutting device is less than ½ the total length of the member.

14. The thread chaser of claim 2 where the bore receives a stud at said one end of the member.

15. The thread chaser of claim 2 where the bore receives a stud at said another end of the member.

16. The thread chaser of claim 2 where the bore receives a stud either at said one end of the member or at said another end of the member.

17. A thread chaser device comprising:
an elongated member having a bore formed therein;
a coupling mechanism formed at one end of the member;
a thread cutting device formed at the other end of the member, said bore being unthreaded for a major portion of its length.

18. The thread chaser device of claim 17 wherein said thread cutting device comprises threads.

19. A kit comprising:
a plurality of thread chaser devices, at least two of said thread chaser devices comprising:
an elongated member;
a coupling mechanism formed at one end of the member;
a thread cutting device formed at the other end of the member and spaced from the coupling mechanism.

20. The kit of claim 19 further comprising a handle.

21. The kit of claim 19 further comprising another thread chaser.

22. The kit of claim 19 further comprising a closeable case.

23. The kit of claim 19 further comprising a tap.

24. A thread chaser device comprising:
an elongated member having a longitudinal axis;
a coupling mechanism integrally formed at one end of the member;
a thread cutting device integrally formed at another end of the member and spaced from at least a portion of the coupling mechanism along the longitudinal axis.

25. A thread chaser device comprising:
an elongated member having a bore formed therein;
a coupling mechanism integrally formed at one end of the member;
a thread cutting device integrally formed at the other end of the member, said bore being unthreaded for a major portion of its length.
